(19) United States
(12) Patent Application Publication
(10) Pub. No.: US 2010/0076895 A1
(43) Pub. Date: Mar. 25, 2010

(54) APPARATUS AND METHODS FOR CUSTOMER INTERACTION MANAGEMENT

(75) Inventors: Hazel R. Spencer, Kansas City, MO (US); Lincoln A. Baxter, Charlotte, NC (US); David Welch, Charlotte, NC (US)

Correspondence Address: Weiss & Arons, LLP, 1540 Route 202, Suite 8, Pomona, NY, 10970, US

(73) Assignee: Bank of America, Charlotte, NC (US)

(21) Appl. No.: 12/237,058

(22) Filed: Sep. 24, 2008

(51) Int. Cl. G06Q 30/00; G06Q 10/00

(52) U.S. Cl. 705/80; 705/10

(57) ABSTRACT

Apparatus and methods for selecting an offer for presentation to a customer of a bank are provided. The methods may include optimizing historical customer data; selecting an offer based on the historical customer data; and, based at least in part on recent customer data, determining whether to present the offer to the customer. Optimizing the historical data may involve performing batch processing on the historical data. The recent customer data may be updated in real time. Offers may be generated and selected for presentation to the customer based on the historical data, the recent data and rules. One or more offers that are generated may be removed from consideration based on the recent customer data, which may provide real-time information about the customer and/or the customer's needs.

### FIELD OF TECHNOLOGY

Aspects of the disclosure relate to managing customer interaction. In particular, the disclosure relates to strategic presentation of offers of goods and services to customers.

### BACKGROUND

Retail businesses formulate offers of goods and services to meet the needs of customers and prospective customers. Such a business may offer many different goods and services to meet the customers' needs. The business may present the offers to the customers via different channels. For example, the business may present the offers to the customers in the course of interactions between the customers and the business's customer services associates, by direct mail, regular advertising, internet advertising, business web site offers and the like.

Financial services institutions typically offer a wide range of products and services. The institutions' customer service associates interact with many customers. Each interaction is an opportunity to present a new offer to a customer. Typically, the interaction is brief, as it is when a customer interacts with a bank teller. During a brief interaction, there is little time for an associate to assess the customer's needs and identify an appropriate product to offer the customer. Without information about the customer, it is typically unlikely that the associate will be able to select an offer that the customer is likely to accept.

Also, it is unlikely that the associate will be able to proactively avoid selecting an offer that already has been presented to the customer via a different associate or a different channel. In some instances, redundant offers may suggest to the customer that the financial institution is not aware of the customer's needs. Such offers may alienate customers from the financial institution and thereby adversely affect the development of customer relationships.

Financial institutions have been known to gather information about customers. The information helps customer service associates select appropriate offers for presentation. The financial institutions typically use data analysis engines to correlate a customer with offers that the customer is likely to accept. Because a financial institution may have a large number of customers, a large number of offers, and a history of offer acceptance and rejection by some or all of the customers, analysis engines may be required to process vast quantities of data to correlate customers with offers that they are likely to accept. Customer service operational systems allow customer service associates to access output from the analysis engines during interactions with customers.

Because of the processing time required to process the customer and offer data, and because customer interactions are typically so short, it may be difficult for the analysis engines to provide a customer service associate with up-to-date recommended offers during the short time between the customer's initiation of the interaction and the end of the interaction.

Some financial institutions, therefore, analyze customer information in batch jobs and keep resulting offer information on file. The offer information may then be accessed by a customer service associate when the customer initiates an interaction. Batch jobs may take days or weeks to run and store. The results may require extensive and expensive storage resources.

Because batch jobs take so long to run and store, they may interfere with customer service operational systems and/or make them unavailable to customer service associates. When such an interference occurs, the financial institution may lose opportunities to present offers to customers.

Also because batch jobs take so long to run and store, the resulting offers may be based on outdated or “stale” customer information and outdated offer information. When stale information is used, offers may be outdated, inappropriate, unnecessary, duplicative or otherwise unsuitable for the customer. When a customer receives such an offer, it is unlikely that the offer will be accepted and there is a risk that the customer will be alienated from the financial institution.

A stale offer may be especially detrimental to the financial institution's relationship with a customer when the offer duplicates an earlier offer that the customer rejected. This is especially likely to happen when the customer interacts with the financial institution through numerous channels.

Some financial institutions maintain “real time” information. The real time information may include data about customers and their activities. The real time data includes short-term history of customer interactions with the financial institution. For example, it may include a record that on a day within the past week, the customer opened a free checking account at the financial institution. Processing requirements for the real time data are not as great as they are for the historical data, so real time data can be quickly accessed by a customer service representative. Real time data, however, does not include the depth of knowledge included in the historical data. The real time data, therefore, is not as valuable for offer selection as is the historical data.

It would be desirable, therefore, to provide apparatus and methods for using both historical and real time data to identify offers during an interaction between a customer and a customer service associate.

### SUMMARY OF THE INVENTION

It is an object of this invention to provide apparatus and methods for selecting an offer of a banking product or service for presentation to a customer. Apparatus and methods may relate to optimizing historical customer data, selecting one or more offers based on the historical customer data and determining whether to present the offer to the customer based at least in part on recent customer data that is generated after historical data files are closed for optimization processes.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is a schematic diagram of digital computing apparatus which may be used in accordance with the principles of the invention;

FIG. 2 shows data flow in accordance with the principles of the invention;

FIG. 3 shows further data flow in accordance with the principles of the invention;

FIG. 4 shows an information tool in accordance with the principles of the invention; and

FIG. 5 shows another information tool in accordance with the principles of the invention.

### DETAILED DESCRIPTION OF EMBODIMENTS

Apparatus and methods for selecting an offer for a product or service for presentation by an entity to a customer of the entity are provided. The methods may include optimizing historical customer data; selecting an offer based on the historical customer data; and, based at least in part on recent customer data, determining whether to present the offer to the customer.

The recent customer data may include current customer profile information, customer-entity relationship state information and/or any other suitable information. The current customer profile information may include customer personal information, customer financial information, and/or any other suitable customer information.

The customer-entity relationship state information may include a date on which the customer first interacted with the entity, a date on which the customer first enrolled in an entity program, a date on which the customer first purchased an entity product, the dates of subsequent enrollment and termination of the customer in other entity services, the dates of subsequent acquisition of entity products, customer financial and credit behavior in connection with entity services and products, notes relating to customer-entity interactions, customer satisfaction and/or complaint notes and any other suitable customer-entity relationship data.

The apparatus may be configured to perform steps related to one or more of the methods. The entity may be any business that sells products and/or services. The entity may desire to understand the history of interactions with the customer. The entity may desire to avoid “over-touching” the customer.

The entity may be a financial institution. For example, the entity may be a banking institution. In the illustrative apparatus and methods shown and described herein, the entity will be described and referred to as a bank or a banking institution.

The historical customer data may relate to any suitable customer history factors. Examples of customer history factors include: a) the number of times that the banking institution previously has presented marketing information to a customer; b) the price that the customer is most likely to accept; and c) the best order in which to offer products and services to the customer such that banking institution share holder value is maximized. Optimal pricing may be based at least partly on assumptions about the customer's needs and how the customer responded to offers that were previously presented to the customer.

The historical data may be used to identify and/or formulate offers that the customer is likely to accept and that, if accepted, would provide value to the banking institution. The offers may be for bank accounts, credit card accounts, lines of credit, mortgages or any other types of banking institution products and services. In some embodiments, an offer may relate to a joint business ventures, for example between the banking institution and affinity partners in different industries or markets. In some embodiments, the apparatus and methods may be used to optimize data for selecting customer treatment in the context of banking institution risk management and loss prevention.

The optimizing of the historical customer data may be performed in a central location by one or more processors. The optimizing may be performed by a network of distributed processors. The optimized data may be distributed to customer service associates that are distributed over a wide geographic area, one or more lines of business within a financial institution and/or one or more different channels of customer interaction. The distributed customer service associates may thus interact with the customer based upon an integrated body of information. This may help build and/or deepen the relationship between the customer and the banking institution.

The optimizing may involve analyzing records of interactions between the banking institution and the customer. The interactions may include personal interactions between the customer and a customer service associate, postal and electronic mail communication, telephone communication and web site visits by the customer. The interaction may be based on marketing material, transactional information (such as banking and credit records) and any other suitable information or material.

The identification and formulation of offers may involve applying business and/or marketing rules to the optimized data. For example, a rule may be triggered by an attribute of a customer's banking-related behavior. The attributes may correspond to spending behavior, cash flow, investment behavior or any other suitable attributes. Another rule may associate one or more of the attributes with a product available for offer. Another rule may suggest that the product be offered to the customer. The rules may function so as to suggest an offer that is likely to be accepted by the customer.

Table A-1 (in the Appendix) shows illustrative rules in accordance with the principles of the invention. The rules may be revised to reflect banking institution management business strategy. Outcomes, such as offer acceptance rates, may be used select and revise the rules, the offers, sales and marketing strategies and other business-related parameters.

Optimizing the historical records may require significant processing resources. The records may be processed as a batch. The batch may take days, weeks, months or longer, to run. The output of the optimization may be a synoptic data set for each customer. The synoptic data set may represent attributes of the customer's banking-related behavior. Each synoptic data set may be identified by an ID number that corresponds to the customer.

Because the synoptic data set is based on the historical customer data, the synoptic data set may reflect one or more assumptions about offers that the banking institution has already presented to the customer. The synoptic data set may be based on one or more assumptions about products that the customer has already acquired (or has “in his wallet”).

While the batch job is running, the banking institution may present to the customer new offers. The customer may accept or reject one or more of the offers. Other interactions may take place between the customer and the banking institution. Thus, the results of the batch job, viz., the synoptic data set, may be out-dated.

The recent customer data may be used to determine whether or not to suggest an offer-which may be based at least in part on historical data-to the customer. The recent customer data may include records of recent interactions between the banking institution and the customer. The records may have features that are similar to the features of the historical records above.

The recent customer data is compiled in real time based on some or all of the interactions between the customer and the banking institution between the time that the historical data files are closed for running the batch job and the present. “Recent” may span minutes, hours, days, weeks or months, depending on the length of time required to close historical customer data files, perform optimization on the historical customer data files, make available the optimized data and undertake any other appropriate processes.

The recent customer data can be used quickly to prioritize or eliminate offers that are based on out-dated synoptic data. In some embodiments, the recent customer data can be used to prioritize or eliminate the offers in the brief time that a customer is present before a customer service associate or is visiting the banking institution's web site.

The optimized historical customer data and the recent customer data may be physically distributed among devices such that they are rapidly accessible during the course of interaction between the customer and a bank channel. For example, a customer in transit may have a mobile Internet interaction with a banking institution web site. The customer may then enter a banking center and interact with a customer service associate. The recent customer data may include information from the mobile interaction. Based on the mobile interaction, the apparatus and methods of the invention may revise, re-sort, reprioritize, reevaluate or newly select offers included in the optimized historical customer data.

In some embodiments of the invention, the synoptic data set may be implemented as “Offer Optimization Data.” Offer Optimization Data may be a small amount of data associated with a customer. The Offer Optimization Data may be combined with a customer identifier and thus be referred to as “Federated Offer Optimization Data (‘FOOD’),” because it centralizes data for customers that may be distributed over many different geographical market areas. The FOOD may be supplied to a real-time offer management system (“OM”) that integrates the Offer Optimization Data with recent customer data based on rules such as those shown in Table A-1 (see Appendix). The OM may create offers for possible presentation to the customer. After an offer is presented to the customer, the OM may store the offer, in real-time, in an offer database. The offer database may be referred to as the “Offer Federated Repository” (“OFR”).

In some embodiments, the FOOD may be stored in tables that are not dependent on formatting or protocols of the associated offer database server. The tables' contents may not be parsed or understood in any way by the database server, and the tables' format can be changed independent of an integrated release.

The OM may select from the FOOD one or more “good news” offers to present to the customer. Good news offers may range from “activation offers” to notification of promos, to retention and balance building offers. Also, good news offers may include offers for new customer segments, such as customers in a selected annual income range. The FOOD may inform the OM what a line of business within the banking institution wants to offer this customer next. The OM may then take additional data like likelihood to accept (“LTA”) and shareholder value (“SVA”), which may be calculated by the optimization process and stored in the FOOD. The OM may thus sort and/or rank offers (and prioritization across different LOBs) and perform offer frequency suppression to avoid annoying customers.

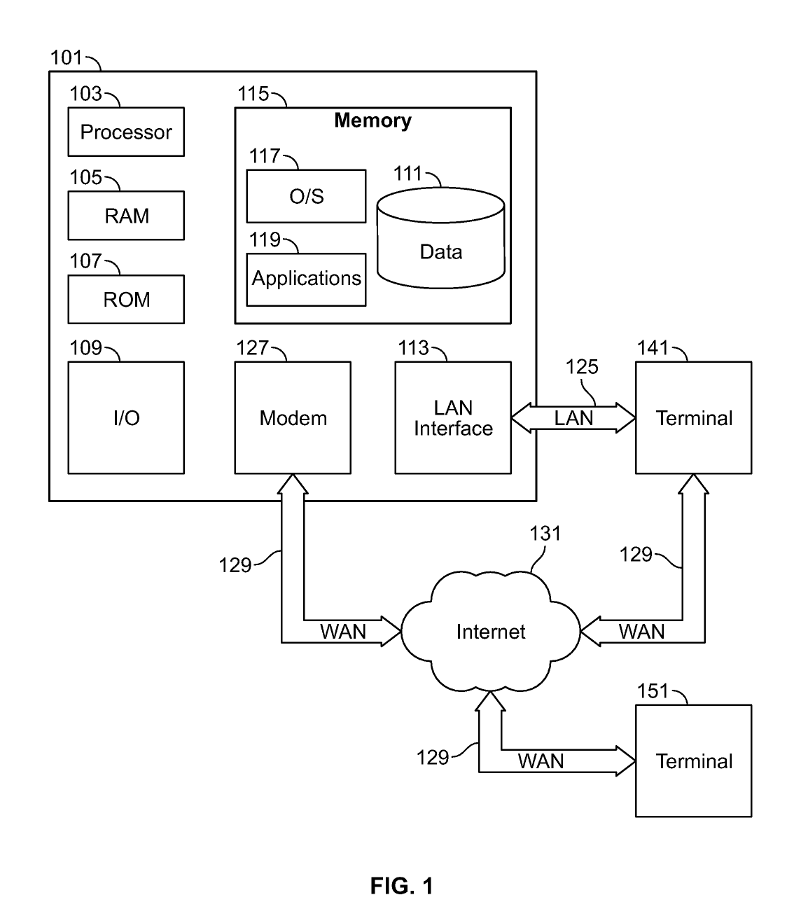

FIGS. 1-5 show illustrative embodiments and features of the invention.

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

FIG. 1 shows a block diagram of an illustrative generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 125.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 125 and/or storage to provide instructions to processor 103 for enabling server 101 to perform various functions. For example, memory 125 may store software used by server 101, such as an operating system 117, application programs 119, and an associated database 121. Alternatively, some or all of server 101 computer executable instructions may be embodied in hardware or firmware (not shown). As described in detail below, database 121 may provide storage for denominational usage information, order archival information and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 311. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A financial institution may use a terminal such as 141 or 151 to access an offers management platform, to control processes related to offers formulation and/or real time customer data or any other suitable tasks. Customer attribute information, including credit application information, may be stored in memory 125. The attribute information may be processed by an application such as one of applications 119.

One or more of applications 119 may include an algorithm that may be used to optimize historical customer data, apply rules, select one or more offers and perform any suitable tasks related to blending historical analytical data and real time data.

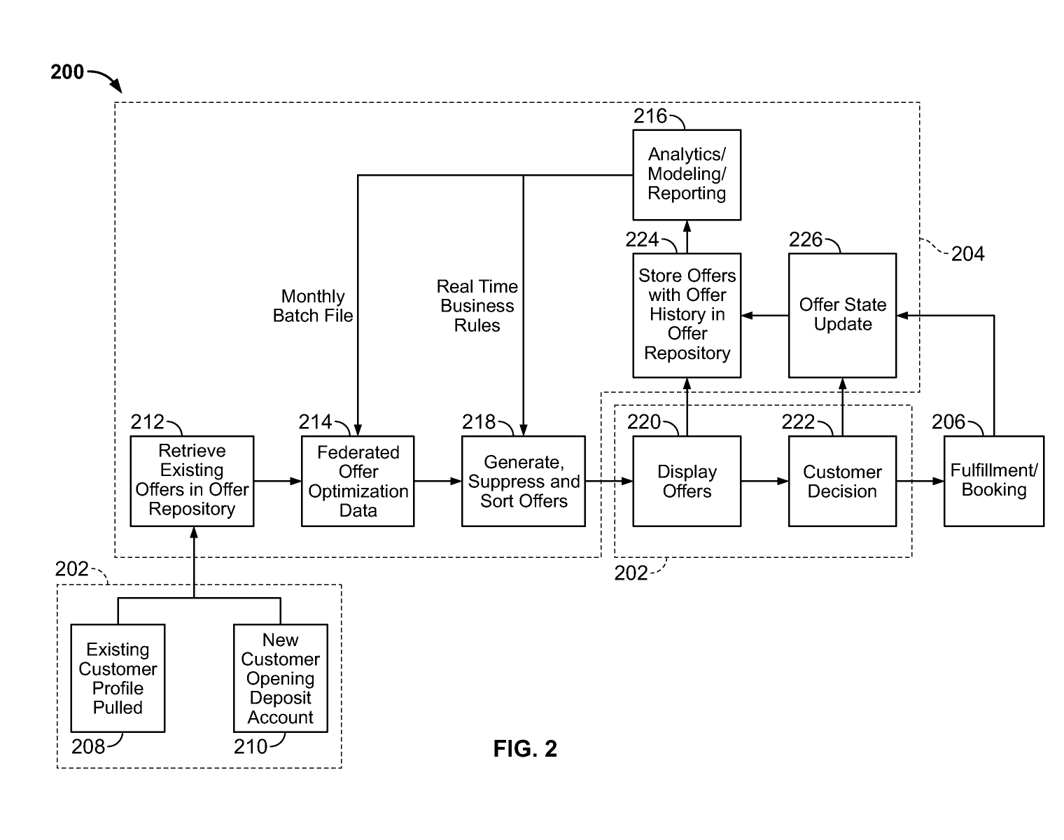

FIG. 2 shows illustrative data flow 200. Data flow 200 may involve process steps, data and processing apparatus. For the sake of illustration, data flow 200 will be described as being governed by a “system.” The system may include one or more of the devices shown in FIG. 1, one or more individuals and/or any other suitable device or approach. The system may be administered and/or controlled by a banking institution.

Flow 200 may include data flow between coordinated platforms such as sales/service platform 202 (appearing in two different portions of FIG. 2), customer interaction and offers management platform 204 and fulfillment/booking platform 206. At process steps 208 and 210, a customer may initiate an interaction with the banking institution. For example, the customer may appear at a teller window or meet with a customer service associate at a conference table. The customer may be identified so that an appropriate offer may be presented to the customer.

At process step 212, the customer service associate may retrieve from an offers repository any offers that were previously presented to the customer. The previously presented offers may be fed into Federated Offer Optimization Data (“FOOD”) 214. (In the context of the apparatus and methods of the invention, “federated” may have the connotation of “centralized.”) FOOD 214 may be optimized data corresponding to the customer. FOOD 214 may also include a monthly batch file that is generated by analytics/modeling/reporting module 216. The monthly batch file may be based on historical customer data. At process step 218, the FOOD may be processed to generate, suppress and sort offers in preparation for selection of an offer for presentation to the customer. The generation, suppression and sorting of offers may be based on rules.

Illustrative rules may be based on customer experience, customer service policy, banking institution policy, banking institution business strategy, regulatory requirements, product or service requirements and/or limitations, banking institution channel policies and/or rules, customer service associate requirements and/or limitations, suppression rules and/or any other suitable banking institution requirements. Illustrative rules are set forth in Table A-1 (see Appendix).

The rules may be provided by analytics/modeling/reporting module 216. FIG. 2 refers to the rules as “real time business rules,” because the rules are used in real time to generate, suppress and sort offers. The real time business rules, however, may be generated based on historical customer data and one or more of the aforementioned banking institution requirements.

Control of data flow 200 may then pass back to sales/service platform 202. At process step 220, the system may display to the customer service associate offers that were output from process step 218. A customer interaction (not shown), such as an interview, presentation or conversation may then lead to the presentation of one or more of the offers to the customer. The presentation may lead to customer decision 222 about a presented offer. If the customer accepts the offer, process 200 may lead to action by fulfillment/booking platform 206. Fulfillment/booking platform 206 may create records and transmit information in connection with delivering products and services related to the accepted offer.

Customer interaction and offers management platform 204 may receive feedback from sales/service platform 202 and/or fulfillment/booking platform 206. For example, offers that are displayed at process step 220 may be transmitted back to customer interaction and offers management platform 204 for storage in the offer repository. The offers may be stored in process step 224. Offers that are stored in process step 224 may be output for subsequent analysis to analytics/modeling/reporting module 216.

Customer decision 222 may be communicated to offer state update module 226. Offer state update module 226 may feed status information about the offer back to analytics/modeling/reporting module 216 via process step 224. The status information may indicate whether the offer was presented to the customer. Fulfillment/booking module 206 may provide status information to offer state update module 226. The status information from fulfillment/booking module 206 may indicate that the offer was accepted by the customer, that an order for one or more products and/or services was booked in the system, and any other suitable status information.

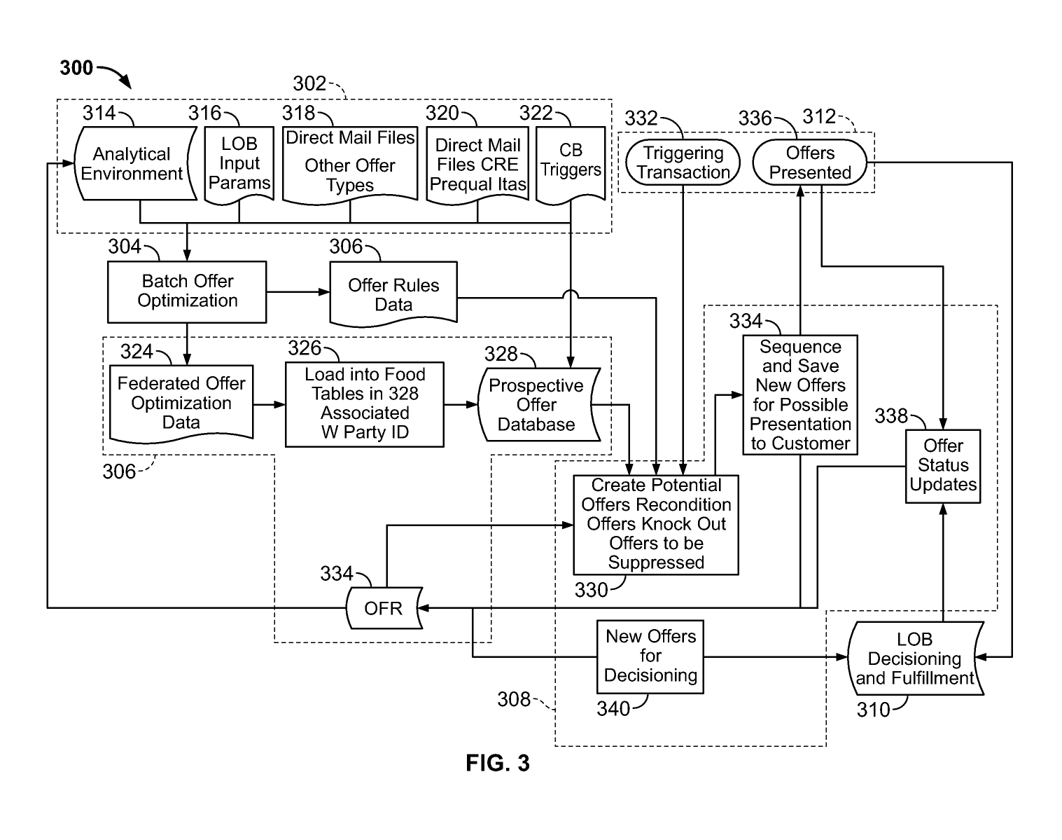

FIG. 3 shows illustrative data flow 300. Illustrative data flow 300 may include some or all of the features of data flow 200 (shown in FIG. 2). Data flow 300 may involve process steps, data and processing apparatus. For the sake of illustration, data flow 300 will be described as being governed by a “system.” The system may include one or more of the devices shown in FIG. 1, one or more individuals and/or any other suitable device or approach. The system may be administered and/or controlled by a banking institution.

Flow 300 may include data flow between coordinated platforms such as historical data input platform 302, batch optimization platform 304, optimized offer data platform 306, offer management platform 308, line of business (“LOB”) decisioning and fulfillment platform 310 and front end platform 312.

Historical data input platform 302 may include one or more modules for providing input data to be used for optimization. Analytical environment 314 may house historical customer data. Line of business (“LOB”) input parameters 316 may be provided by one or more different lines of business of the banking institution. Lines of business may include, for example, retail banking, commercial banking, lending and/or any other suitable lines of business. Direct mail files and other offer types 318 may include customer interaction data from one or more banking channels such as direct mail marketing and credit card solicitation programs, including pre-approved credit programs. Direct mail files 320 may include customer interaction data from consumer real estate files and prequalified invitations to apply for collateralized credit. Credit bureau (“CB”) triggers 322 may include credit alerts or information updates about customers. CB triggers 322 may be received from credit bureaus.

In some embodiments, CB triggers may be optimized along with the data that is provided by historical data input platform 302. In some embodiments, CB triggers may be fed directly into stores of optimized data in optimized offer data platform 306. In some of those embodiments, CB triggers may be fed on a periodic basis (e.g., daily) into the stores of optimized data.

Historical data input platform 302 may include “customer wallet” records. Customer wallet is an inventory of banking institution products and services that the customer has acquired or engaged.

Batch offer optimization platform 304 may receive historical data from platform 302. Any suitable optimization platform may be used. Two such optimization platforms are those sold under the names MarketSwitch and SMG3 by Experian of Costa Mesa, Calif. Batch offer optimization platform 304 may provide at least the following outputs: (1) Federated Offer Optimization Data (“FOOD”) 324; and (2) Optimization Rules Data (“ORD”) 306.

In some embodiments, the FOOD may be implemented as parcels of XML data corresponding to individual customers. The FOOD may relate to product and/or services offers, attributes of a relationship between the banking institution and the customer and any other suitable offers-related information. The XML data may be correspond to the synoptic data sets described above. In some embodiments, the ORD may be implemented as XML rules for generating, suppressing and sorting offers (as shown in process step 218 in FIG. 2).

At process step 326, the FOOD may be loaded, along with associated customer or party ID's into prospective offer data base 328. Control of data flow 300 may then pass to offer management platform 308. Inputs to offer management platform 308 may be received at process step 330. The inputs may include offer rules data 306. In some embodiments, offer rules data 306 may be transmitted to offer management platform 308 on a runtime basis.

The inputs may include customer relationship data and FOOD from prospective offer database 328. The inputs may include information from a customer interaction with a customer service associate such as triggering transaction 332. Triggering transaction 332 may include a customer request for a product or service. In some embodiments the customer request may be transmitted in real time to offer management platform 308. Inputs may also include actual offers (already presented to the customer) from offer federated repository (“OFR”) 334. (Inputs to OFR are discussed below.)

At process step 330, new prospective offers may be created, old offers and old prospective offers may be reconditioned and offers may be suppressed. In some embodiments, offer rules data 306 may be applied to the FOOD before the FOOD are combined with recent customer data from OFR 334. In some embodiments, offer rules data 306 may be applied to the FOOD in combination with recent customer data from OFR 334.

At process step 334, the system may sequence and save new offers for possible presentation to the customer. The new offers may be transmitted to front end platform 312 for presentation by the customer service associate to the customer. The new offers may be presented at offers presented 336. In some embodiments, the system may provide to the customer service associate a “good news” message for presentation along with the offer. The good news message may be about features of the offer or information related to products and services that the customer already has.

When the customer accepts an offer at offers presented 336, the customer service associate may transmit to line of business decisioning and fulfillment 310 an application for a product or service corresponding to the accepted offer. The application may include a fulfillment request. Line of business decisioning and fulfillment 310 may decide whether to grant (or “book”) applications and requests based on an offer.

Status information about such decisions may be provided to offer status updates 338. When an offer is accepted or rejected, offer status information may be updated and transmitted to offer status updates module 338. Updated customer information may also be transmitted to offer status updates module 338. The updated customer and offer information may then be transmitted OFR 334. New offers from sequence and save new offers for possible presentation to customer 334 may transmit the new offers to OFR 334.

Based on the inputs to OFR 334, the system may maintain real-time “awareness” for each customer of the offers that have been formulated, presented, accepted and rejected. The system may also maintain a real-time awareness of information related to the customer. Information related to the customer may relate to the customer's personal information, financial information, requests for products and service and/or any other suitable information.

OFR 334 may feed this information back to process step 330 for use in subsequent customer transactions that may occur before the next batch offer optimization (at batch offer optimization platform 304). OFR 334 may feed this information back to analytical environment 314 for inclusion in a future batch offer optimization job at batch offer optimization platform 304. In some embodiments, OFR 334 may feed the information back to analytical environment 314 on a daily basis.

Offer management platform 308 may include new offers for decisioning module 340. Module 340 may provide new offers from any source. For example, the source may include banking institution management, customer service associates (perhaps based on customer interactions), different banking institution lines of business or any other suitable source.

In some embodiments, module 340 may transmit the new offers to line of business and fulfillment platform 310. The new offers may be evaluated and/or revised at platform 310. The new offers may be provided with status information and transmitted to offer status updates module 338 for further processing. In some embodiments, module 340 may transmit the new offers directly to OFR 334, for further processing at process step 330 and transmission to analytical environment 314.

When a customer interacts with the customer service associate that is using front end system 312, a real-time data request is made to offer management platform 308. Upon receipt of this request management platform 308:
1. Reads customer relationship data not provided in the request from prospective offer database 328. The read data may include customer demographics, account data, suppression data (like DNS, Fraud, Member Trade, etc), and the daily bureau triggers (for the customer);
2. Reads the FOOD for this customer from prospective offer database 328; and
3. Reads existing offers for this customer from OFR 334.

Offer management platform 308 turns the FOOD for this customer into potential offers in memory, combining them with the existing offers which were read from the OFR. Offer management platform 308 then begins the process of eliminating that which is no longer relevant, desirable, appropriate and/or timely for offering to this customer.

For example, if the customer has recently applied for a product that the FOOD instructed offer management platform 308 to offer, that offer would be eliminated. At this stage the existing offers may be “reconditioned” if the FOOD so instructs. A decision may then be made about whether to retrieve one or more real-time prescreened offers. The prescreened offer may be any suitable offer, such as a credit offer and/or a credit card offer, for example.

Once one or more offers are determined, sorting and ordering is done, and depending on display and fulfillment capabilities of the front end channel, the list is pruned of those offers that cannot or should not be made. This process may include enterprise and LOB frequency presentation suppression logic (to reduce the likelihood of “overtouching” the customer too frequently), and channel filtering rules (to avoid cross-channel offer redundancy). Remaining offers may be saved or updated to the OFR and may be returned to the front end 312 for presentation.

Front end 312 may send updates to offer management platform 308 indicating what has happened for each offer received from offer management platform 308: Was it suppressed by the front end system (NOT OFFERED—“The system suppressed the display”)? Was it displayed but the associate took no action? (NOT OFFERED—“The associate took no action”). Was it displayed and statused by the associate? (NOT OFFERED—“The sales situation was bad.”, INTERESTED—“A referral was created and placed in shopping basket”, REFUSED—various reasons, UNDECIDED, SUBMITTED—for booking, etc). All of these are examples of offer states, and reasons for offer state transitions.

When an Offer is SUBMITTED to line of business decisioning and fulfillment 310 for booking, or an application is created (in the case of an Invitation to Apply), the fulfillment system may a) update offer management platform 308 with the fulfillment results and b) if no offer is presented from the front-end, retrieve an offer from offer management platform 308 (UNDER CONSIDERATION) and update it (APPROVED, PENDED, DECLINED, BOOKED, etc.) with the decision statuses as they change, until a terminal status is reached (DECLINED, BOOKED, WITHDRAWN, etc).

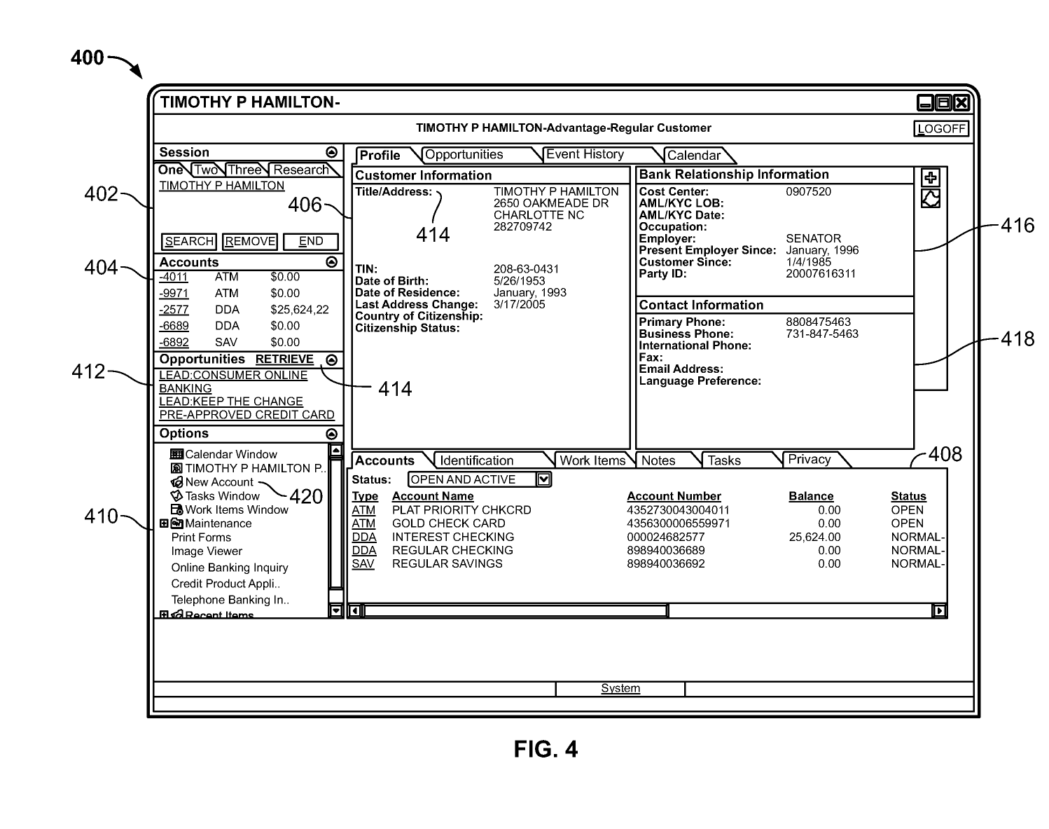

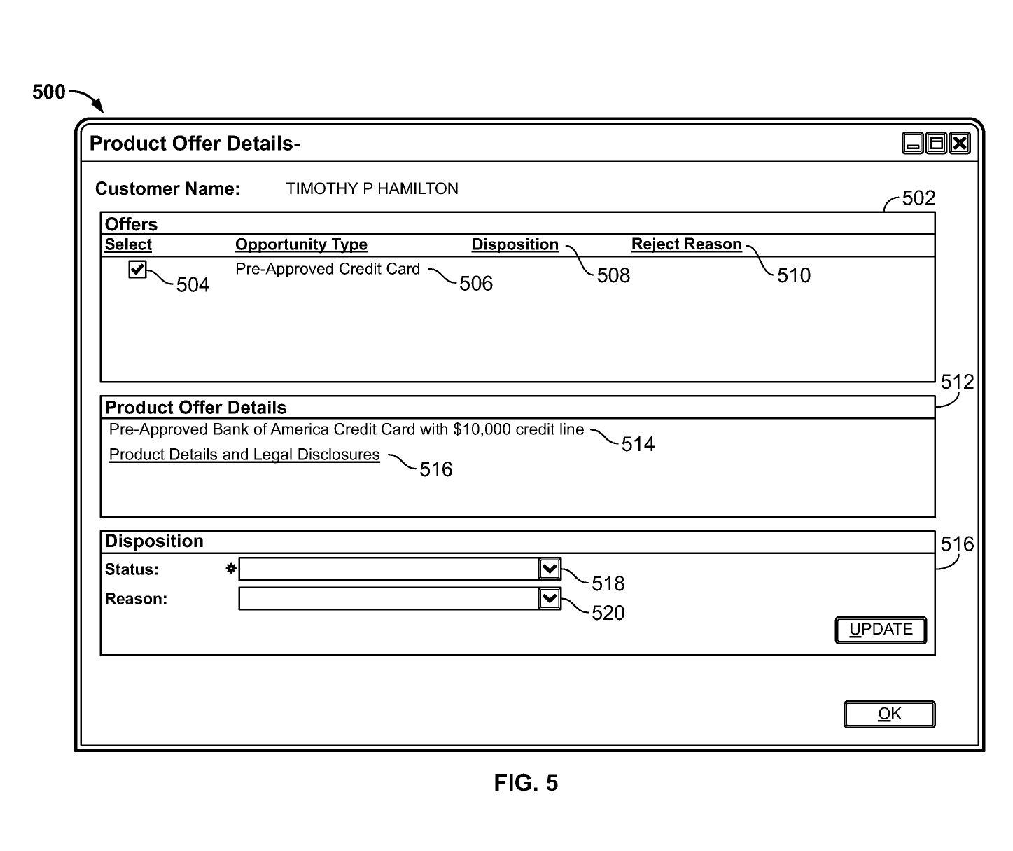

FIGS. 4 and 5 show web page views that the customer service associate may use during an interaction with a customer to select an offer for presentation to the customer.

FIG. 4 shows illustrative customer view 400. View 400 may include session pane 402, accounts pane 404, tabbed panes 406, tabbed panes 408, options pane 410 and opportunities pane 412. Session pane 402 may be used to select a customer for whom to view data. Accounts pane 404 includes links to the customer's accounts at the banking institution. Tabbed panes 406 include, at a profile tab, personal customer information 414, bank relationship information 416 and customer contact information 418. Tabbed panes 408 include, at an accounts tab, data related to the customers accounts at the banking institution. Options pane 410 includes links to functions that may be initiated by the customer service associate. For example, the associate may use new account link 420 to initiate the process of opening a new account for the customer. The new account may be an account that is the subject of an offer that the associate presented to the customer.

Opportunities pane 412 may include links to leads and/or offers. A lead may be a message generated by a customer service associate or any other individual or module that previously interacted with the customer. The message may identify statements made by the customer that suggest a need or desire for banking services. The message may alert the customer service associate that is presently interacting with the customer that the customer is likely to accept a particular offer or a particular type of offer.

An offer having a link in opportunities pane 412 may be an offer generated by offers management platform 308 (shown in FIG. 3). Opportunities pane 412 may be populated with leads and/or opportunities automatically. Opportunities pane 412 may include retrieve control 414 to manually populated opportunities pane 412.

FIG. 5 shows product offer details view 500 that the customer service associate may obtain. The customer service associate may obtain offer details view 500 by clicking on new account link 420 (shown in FIG. 4), by clicking on an offer link in opportunities pane 412 (shown in FIG. 4) or by any other suitable approach. View 500 may include offers pane 502. Offers pane 502 may show one or more (or all) of the offers generated by offers management platform 308 (shown in FIG. 3). Offers pane 502 may include selection boxes such as 504, opportunity types such as pre-approved credit card offer 506, dispositions 508 and reject reason 510. No disposition or reject reason is shown for the pre-approved credit card, because view 500 is shown at a time before the offer customer has responded to the offer.

Product offer details view 500 may include product offer details pane 512. Pane 512 may include product details such as description 514. Pane 512 may include a link such as 516 to more product details. The details may include product features, restrictions, terms and conditions and any other suitable details.

Product offer details view 500 may include disposition pane 516. Disposition pane 516 may receive from the customer service associate information regarding the disposition of an offer. Disposition pane 516 may include status selector 518, reason selector 520 and any other suitable disposition selectors. Table 1 shows examples of statuses and corresponding reasons.

TABLE 1
Examples of statuses and reasons.

| Status | Reason(s) |
|---|---|
| NOT OFFERED | The system suppressed |
| | the display |
| | The associate took no |
| | action |
| | The sales situation |
| | was bad |
| INTERESTED | A referral was created and |
| REFUSED | placed in shopping basket |
| | The customer was not |
| | interested |
| | The customer desired a |
| | higher credit limit |
| | The customer does not |
| | like online services |
| UNDECIDED | |
| SUBMITTED (e.g., to LOB | The customer accepted offer |
| descisioning and | and requested enrollment |
| fulfillment platform 310 | |
| (shown in FIG. 3) | |

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention is described herein in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Aspects of the invention are described herein in terms of illustrative embodiments thereof. A person having ordinary skill in the art will appreciate that numerous additional embodiments, modifications, and variations may exist that remain within the scope and spirit of the appended claims. For example, one of ordinary skill in the art will appreciate that the steps illustrated in the figures may be performed in other than the recited order and that one or more steps illustrated may be optional. The methods and systems of the above-referenced embodiments may also include other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, apparatus and methods for selecting a service and/or product for presentation by an entity to a customer have been provided. Persons skilled in the art will appreciate that the present invention can be practiced by other than the described embodiments, which are presented for purposes of illustration rather than of limitation, and that the present invention is limited only by the claims that follow.

| | | | | | Multiple | | | |
|---|---|---|---|---|---|---|---|---|
| | | | | | Instances w/ | | | |
| | | | | | Different | | Offer | |
| Process | Rule | Rules | | Configurable | Values at | | Map- | Rule |
| Stage | i.d. | [brackets denote configurable value] | Desired Action | Elements | Launch? | Comments | ping | Level |
| A | Deliver Offers Management Product Set | | | | | | | |
| | 1 | For party collection range [xxx to yyy using specific digits of | Create launch | | | The percent of population using | | Enterprise |
| | | the party collection i.d.] with Segment Type [using customer | Champion strategy | | | this strategy will reduce in regular | | |
| | | segment type], exactly replicate Offers Management | that mirrors the pre- | | | intervals over time to 0% as | | |
| | | Generation 1 offer generation rules and sequencing process. | OM environment | | | random digits are moved out of | | |
| | | | | | | this strategy. | | |
| B | Read OFR | | | | | | | |
| C | Create Offers from Batch Optimizer Pre-Optimized File | | | | | | | |
| D | De-Dupe and Copy priorities and other data to existing OFR offers | | | | | | | |
| E | Filter Offers via Customer Experience Suppressions | | | | | | | |
| | 1 | For party collection i.d. range [xxx to yyy using specified | Suppress offers | party collection digits; | 8 Instances: Mass | example: Challenger strategy will | All | Customer |
| | | digits of the party collection i.d.], with Segment Type [Using | based on security | Customer Segment; Offer | Affluent Offer type X; | allow Mass Affluent Customers to | | Experience |
| | | Customer Segment Type], Suppress Offer Types [Using | breech notification. | Type; Offer Category; | Mass Affluent Offer | receive service offers regardless | | |
| | | Offer type and/or Offer Category] for customers who have | | Number of Days | Type all other; Other | of the breech notification while | | |
| | | had a security breech within [xxx using # of days]. | | | Segments Offer | restricting all other offer types for | | |
| | | | | | Type X; Other | MA for 60 days and all offer types | | |
| | | | | | Segments Offer | for all other segments for 60 | | |
| | | | | | Type all other; | days. | | |
| | | | | | Champion versions | | | |
| | | | | | & Challenger | | | |
| | | | | | Versions of each | | | |
| | | | | | above | | | |
| | 2 | For party collection i.d. range [xxx to yyy using specified | Frequency | party collection digits; | 6 Instances: Mass | example: Challenger strategy will | All | Enterprise: |
| | | digits of the party collection i.d.], with Segment Type [Using | suppression | Customer Segment; Offer | Affluent Champion; | suppress more than 6 offers of | | Customer |
| | | Customer Segment Type]. Suppress Offer Types [Using | | Type; Offer creation date; | Other Segments | any offer type being presented | | Experience |
| | | Offer type and/or Offer Category] for customers who have | | number of offers | Champion; Mass | within 30 days and it will also | | & Customer |
| | | been presented more than [xxx using number of offers | | presented; Offer Category; | Affluent Challenger | suppress more than 4 acquisition | | Segment |
| | | presented] of [Using Offer type and/or Offer Category] within | | Numher of Days | 1; Mass Affluent | offer types being presented within | | |
| | | the last [xxx using # of days]. | | | Challenger 2; Other | 30 days. | | |
| | | | | | Challenger 1; Other | DOE Notes: Launch with two | | |
| | | | | | Challenger 2 | challengers for primary segments | | |
| | | | | | | to determine elasticity from 3 | | |
| | | | | | | observation points on frequency | | |
| | | | | | | volume. | | |
| | 3 | For party collection i.d. range [xxx to yyy using specified | Batch File Frequency | party collection digits; | | example: The challenger strategy | All | Enterprise: |
| | | digits of the party collection i.d.], with Segment Type [Using | suppression | Customer Segment; Offer | | will suppress offers of any type | | Customer |
| | | Customer Segment Type], Suppress Offer Types [Using | | Type; number of offers | | being presented within 30 days to | | Experience |
| | | Offer type and/or Offer Category] for customers who have a | | presented; Offer Category; | | Mass Affluent Consumers when | | & Customer |
| | | no-offer indicator from the batch file updated with the last | | Number of Days | | a no-offer indicator is place on | | Segment |
| | | [xxx days]. | | | | the batch file? | | |
| | 4 | For party collection i.d. range [xxx to yyy using specified | Customer Problem | party collection digits; | TBD Incidents: | If Customer Problem Indicator | | Enterprise: |
| | | digits of the party collection i.d.], with Segment Type [Using | Indicator | Customer Segment; Offer | based on Customer | Database Exists. | | Customer |
| | | Customer Segment Type], Suppress Offer Types [Using | | Type; Offer Category; | Problem Indicator | example: Challenger strategy | | Experience |
| | | Offer type and/or Offer Category] for customers who have a | | Customer Problem | Database Details | shall suppress all offers being | | & Customer |
| | | Customer Problem Indicator [Using CP Indicator Type] | | Indicator Type; Number of | | made to consumers in the plus | | Segment |
| | | identified within [xxx using # of days]. | | Days | | and prime segments if they have | | |
| | | | | | | a customer problem indicator | | |
| | | | | | | appended within the last 30 days. | | |
| | 5 | For party collection i.d. range [xxx to yyy using specified | Suppress offers to | party collection, customer | | example: improve customer | | |
| | | digits of the party collection i.d.], with Segment Type [Using | customers who have | segment, offer type or | | experience by not offering a | | |
| | | Customer Segment Type], Suppress Offer Types [Using | recently been | category, | | product or similar product to a | | |
| | | Offer type and/or Offer Category] for customers who have | declined for the same | | | customer that they have been | | |
| | | been declined for [product type] in last [XXX] days | or similar product to | | | declined on very recently | | |
| | | | improve customer | | | | | |
| | | | experience. | | | | | |
| | 6 | If party collection i.d. range [xxx to yyy using specified digits | Suppress offers | party collection id, segment | | | | Enterprise |
| | | of the party collection i.d.] with Segment Type [using | based on geography | type, offer type, offer | | | | & LOB rules |
| | | customer segment type], Suppress offer [offer type and offer | (i.e. natural disaster in | category, banking center | | | | |
| | | category] when customer or banking center zip code equals | New Orleans) | zip code, banking center | | | | |
| | | [xxxxx-xxxxx] or banking center hierarchy code equal [xxxx- | | hierarchy, customer zip | | | | |
| | | xxxx]. | | code | | | | |

Filter Offers via Channel Filter

| | | | | | | | |
|---|---|---|---|---|---|---|---|
| F | 1 | For party collection i.d. range [xxx to yyy using specified | Exclude products | party collection digits; | 10-20 Instances: | example: Champion strategy | Channel |
| | | digits of the party collection i.d.], with Segment Type [Using | based on requesting | Customer Segment; Offer | Channel Admin | shall exclude all passive | Admin, |
| | | Customer Segment Type] or recondition indicator | channel and | Type; Offer Category; | Version & LOB | mortgage offers from the teller | Customer |
| | | [reconditioned offer indicator] Suppress Offer Types [Using | customer segments | Number of Days; | Version via | channel. | Segment & |
| | | Offer type and/or Offer Category], for triggers/from Channel | | Recondition Offer Indicator, | Champion/Challenge | | LOB |
| | | [channel type]. | | Channel Type | Strategies with | | |
| | | | | | Specific | | |
| | | | | | Segment/Offer/ | | |
| | | | | | Channel | | |
| | | | | | Combinations | | |
| | 2 | For party collection i.d. range [xxx to yyy using specified | Exclude products | party collection digits; | | example: | Card |
| | | digits of the party collection i.d.], with Segment Type [Using | based on batch | Customer Segment; batch | | | Services |
| | | Customer Segment Type] or with batch channel use | channel use | channel use propensity | | | LOB |
| | | propensity indicator [value from batch file] Suppress Offer | propensity indicator | flag; Offer Type; number of | | | Specific |
| | | Types [Using Offer type and/or Offer Category], for triggers | | offers presented; Offer | | | |
| | | from Channel [channel type]. | | Category; Number of Days | | | |
| | 3 | For party collection i.d. range [xxx to yyy using specified | Exclude listed MSAs/ | party collection digits; | | example: Due to market | Channel |
| | | digits of the party collection i.d.], with Segment Type [Using | Banking Centers for | Customer Segment; Offer | | condition in select MSA, product | Admin, |
| | | Customer Segment Type], Suppress Offer Types [Using | offer | Type; Offer Category; | | will not be offered - Use | Customer |
| | | Offer type and/or Offer Category], based on Banking Center | | Number of Days; | | Heirarchy to map to MSA | Segment & |
| | | [banking center hierarchy] channel [channel type] Banking | | Recondition Offer Indicator; | | | LOB |
| | | Center Zip Code [xxxxx-xxxxx]. | | Channel Type; Banking | | | |
| | | | | Center # -or- Cost Center | | | |

Determine if valid existing offers: includes reconditioning rules for Card Services offers and LOB Suppressions for Batch Offers based on updated data/events

| | | | | | | |
|---|---|---|---|---|---|---|
| G | 1 | Suppress existing offers which have expired. | Expired offer | none | | LOB |
| | | | suppression | | | Specific |
| | 2 | If party collection i.d. range [xxx to yyy using specified digits | Determine eligible | party collection id, | | Card |
| | | of the party collection i.d.] and optimized card offer type | population for re- | optimized card offer type. | | Services |
| | | equals [activation or retail spend offer] and segment | conditioning of | segment indicator, | | Specific |
| | | indicator (i.e. student, private, premier, mass affluent) equals | activation & retail | customer zip code, banking | | |
| | | [v] and customer zip code equals [a] and banking center zip | spend offers | center zip code, profitability | | |
| | | code equals [b] and profitability indicator on optimized file | | indicator on optimized file. | | |
| | | equals [a] and time since last balance transfer is greater than | | time since last BT, time | | |
| | | [w] and time since last retail purchase is [x] and time since | | since last retail purchase, | | |
| | | last cash advance is [y] and open to buy is greater than [z] | | time since last cash | | |
| | | and previous offer disposition of optimized card offer type | | advance, open to buy, | | |
| | | [activation or retail spend offer] is not [accepted] and has | | previous offer disposition of | | |
| | | been offered [x] times in the last [n] days then set offer | | optimized card offer type, | | |
| | | recondition eligibility to [yes] | | time offered in last n days, | | |
| | | | | offer re-condition eligibility | | |
| | 3 | If party collection i.d. range [xxx to yyy using specified digits | Determine eligible | party collection id, | | |
| | | of the party collection i.d.], with segment type [customer | population for card | optimized card offer type, | | |
| | | segment type] and card offer type [offer type or category | utilization offers (line | segment indicator, | | |
| | | such as utilization: line increase, utilization: price decrease, | increase, price | customer zip code, banking | | |
| | | utilization: product change] and customer zip code equals [a] | decrease, product | center zip code, profitability | | |
| | | and banking center zip code equals [b] and profitabilty | change) | indicator on optimized file. | | |
| | | indicator from optimized file equals [a] and current credit line | | current credit line, current | | |
| | | equals [b] and current purchase APR equals [c] and current | | purchase APR, current BT | | |
| | | BT APR equals [d] current card type equals [e] and time | | APR, current card type, | | |
| | | since last balance transfer is greater than [w] and time since | | time since last BT, time | | |
| | | last retail purchase is [x] and time since last cash advance is | | since last retail purchase, | | |
| | | [y] and open to buy is greater than [z] and previous offer | | time since last cash | | |
| | | disposition of card offer type [utilization] is not [accepted] and | | advance, open to buy, | | |
| | | has been offered [x] times in the last [n] days then set offer | | previous offer disposition of | | |
| | | recondition eligibility to [yes] | | optimized card offer type, | | |
| | | | | time offered in last n days, | | |
| | | | | offer re-condition eligibility | | |
| | 4 | If party collection i.d. range [xxx to yyy using specified digits | Determine eligible | party collection id, | 1 instance of a | |
| | | of the party collection i.d.] and optimized card offer type | population for first | optimized card offer type, | variable that has a | |
| | | equals [first card or second/multi card] and has been offered | card and second/multi | offered x times in last n | finite number of | |
| | | [x] times in the last [n] days and previous offer disposition of | card offers | days, previous offer | values (i.e. | |
| | | optimized card offer type [first card or second/multi card] is | | disposition of optimized | approximately 500 | |
| | | [declined] and decline reason equals [line too low or rate too | | card offer type, decline | card products | |
| | | high] or previous offer disposition of card offer type [first card | | reason, offer re-condition | available via BC | |
| | | or second/multi card] is [undecided] then set offer recondition | | eligibility | channel): product | |
| | | eligibility to [yes] | | | offer based on | |
| | | | | | optimized card | |
| | | | | | product | |
| | | | | | recommendation | |
| | 5 | If party collection i.d. range [xxx to yyy using specified digits | Reconditioning sub- | party collection id, | | Card |
| | | of the party collection i.d.], with segment type [customer | rules | optimized card offer type, | | Services |
| | | segment type] and card offer type to be recondition equals | | offer re-condition eligibility, | | Specific |
| | | [offer type or category] and offer re-condition eligibility equals | | next highest offer value, | | |
| | | [yes], then present the next best offer based on sub-rule | | previous offer value | | |
| | | 8.3.7.2 through 8.3.7.X | | | | |
| | 6a | A) Offer to be reconditioned is [offer type or category] and | Determine re- | party collection id, | | Card |
| | | Offer State [Offer State code] with reason [Offer reason | conditioned offer for | optimized card offer type, | | Services |
| | | code] [and/or] prior verions of the offer was [Offer type or | card utilization offers | card type(s), offer re- | | Specific |
| | | Offer Category] [and/or] the offer was previously [offer type | (line increase, price | condition eligibility, | | |
| | | or category] [more than/less than/equal to] [X] number of | decrease, product | | | |
| | | times then change offer attribute [offer attribute such as line | change) | | | |
| | | size, price or product]. | | | | |
| | 6b | B) When attribute to be changed is line size, increase line | reconditioning lines | Fico Score, Line Size Table | | Card |
| | | using card services approved line size table which will | | | | Services |
| | | include fico score | | | | Specific |
| | 6c | C) When attribute to be changed is price, decrease interest | reconditioning price | Fico Score, Profit Score, | | Card |
| | | rate to next lowest value using card services approved | | Price Table | | Services |
| | | pricing table which will include fico score and profit score | | | | Specific |
| | | from batch file. | | | | |
| | 6d | D) When attribute to be reconditioned is product, change | reconditioning product | Affinity relationship | | Card |
| | | offer to new product using product reconditioning table | | indicator, product | | Services |
| | | | | ownership: product table | | Specific |

Evaluate what customer has/needs

| | | | | | | | |
|---|---|---|---|---|---|---|---|
| H | 1 | For party collection i.d. range [xxx to yyy using specific digits | Suppress offers | collection i.d.; Customer | | | LOB |
| | | of the party collection i.d.] with Segment Type [using | based on application | Setment Type; Offer Type: | | | Specific |
| | | Customer Segment Type]. Suppress offer type [using offer | in process for same | Offer Category | | | |
| | | type and offer category] with an applications in process for | or similar products. | | | | |
| | | [product type]. | | | | | |
| | 2 | For party collection i.d. range [xxx to yyy using specific digits | Suppress | collection i.d.; Customer | | | LOB |
| | | of the party collection i.d.] with Segment Type [using | SUBMITTED offers. | Segment Type; Offer Type; | | | Specific |
| | | Customer Segment Type]. Suppress all offers with | | Offer Category; Offer State | | | |
| | | SUBMITTED offer state | | | | | |
| | 3 | For party collection i.d. range [xxx to yyy using specific digits | Suppress offers with | collection i.d.; Customer | | | LOB |
| | | of the party collection i.d.] with Segment Type [using | specific offer states | Segment Type; Offer Type: | | | Specific |
| | | Customer Segment Type]. Suppress offers [Offer Type or | and offer state reason | Offer Category; Offer | | | |
| | | Category] with offer states [state] and offer state reason | codes. | State; Offer State Reason | | | |
| | | codes [offer state reason code].. | | Code | | | |
| | 4 | For party collection i.d. range [xxx to yyy using specific digits | Suppress offers | collection i.d.: Customer | | Configurable values allows | LOB |
| | | of the party collection i.d.] with Segment Type [using | based on existing | Segment Type; Offer Type; | | options around suppression | Specific |
| | | Customer Segment Type], Suppress offer type [using offer | ownership. | Offer Category; Number of | | based on number of identical | |
| | | type and offer category] when the party [use party or | | existing; party/collection | | products/features/services; how | |
| | | collection] has [use less than, equal to or more than] number | | level ownership; Values | | recently they were added and if | |
| | | [use number] existing accounts or features of type [use | | more/less/equal; Number | | they are owned by the party or | |
| | | product type] opened or added [more than or less than] | | of days | | the party collection. | |
| | | number days ago [use number of days]. | | | | | |
| | 5 | For party collection i.d. range [xxx to yyy] with segment type | Suppress offers | collection i.d., customer | | | LOB |
| | | [using customer segment type], If any account type [account | based on updated | segment, account type, | | | Specific |
| | | type such as credit] owned by the party has a status [x] or | account status, | account status, account | | | |
| | | accounts delinquency is [x] then suppress offers type [offer | activity for similar | activity code, offer type, | | | |
| | | type and category] | account types | offer category | | | |
| | 6 | For party collection i.d. range [xxx to yyy] with segment type | Suppress offers | collection i.d., customer | | | LOB |
| | | [using customer segment type], If existing account [use | based on updated | segment, account type, | | | Specific |
| | | account type] status is [x], account delinquency is [x] or | account status, | account status, account | | | |
| | | account activity is [y] and time on books is [z] then suppress | activity and time on | activity code, account time | | | |
| | | offers type [offer type and category] | books | on books, offer type, offer | | | |
| | | | | category | | | |
| | 7 | If party collection i.d. range [xxx to yyy] with Segment Type | Suppress offers | party collection i.d., | | | LOB |
| | | [using customer segment type], suppress offers [offer type or | based on offer history | customer segment code, | | | Specific |
| | | offer category] with offer create date [any, more than, less | | offer type, offer category, | | | |
| | | than] [x] days prior and/or presented more than [x] times in | | offer create date, date of | | | |
| | | last [x] days with offer state or disposition of [offer state and | | last offer presentment. | | | |
| | | disposition] and previous offer channel [type, or same as | | number of times presented | | | |
| | | triggering type]. | | in x days, previous offer | | | |
| | | | | state or disposition, | | | |
| | | | | previous offer channel. | | | |
| | 8 | If party collection i.d. range [xxx to yyy using specified digits | Determine eligibility | party collection i.d., | 14 instances: 6 offer | If we use batch offers, then can | LOB |
| | | of the party collection i.d.] with Segment Type [using | for certain card offer | customer segment type, | types [activation | we replace this with a much | Specific |
| | | customer segment type], suppress offers [offer type or | categories using | offer type, offer category, | reminder non- | simpler rule? This rule is | |
| | | category] if existing product type [equals or does not equal] | account level | existing product type, time | rewards card (1), | dependent on Card Services | |
| | | [product type] and time since last [transaction activity type 1] | transaction data in | since last Transaction type | activation reminder | Activity or Transaction Types | |
| | | is greater than [x] days [and/or] time since last [transaction | real time | (examples: balance | rewards card (1), | such as retail spend, cash | |
| | | type 2] or [transaction type 3] is [equal, more or less] than [y] | | transfer, retail purchase, | activation reminder + | advance or balance transfers | |
| | | or available credit is less than [$x, xxx]. | | cash advance), Available | incentive non- | being observed in real time. | |
| | | | | Credit | rewards card (3), | Attributes for Card in CTCS | |
| | | | | | activation reminder + | | |
| | | | | | incentive rewards | | |
| | | | | | card (3), retail spend | | |
| | | | | | offer non-rewards | | |
| | | | | | card (3), retail spend | | |
| | | | | | offer rewards card | | |
| | | | | | (3)] | | |
| | 9 | If party collection i.d. range [xxx to yyy using specified digits | category of offers now | Offer Type; Offer Category; | | example: recent rejection of | LOB |
| | | of the party collection i.d.] with Segment Type [using | ineligible based on a | Disposition Code | | similar offers | Specific |
| | | customer segment type] Suppress offer category [using | recent offer state | | | | |
| | | offer type and offer category] when prior offer of [offer type or | code and offer state | | | | |
| | | category] received a Offer State code [Offer State code] with | reason code | | | | |
| | | Offer State Reason Code [Offer State Reason Code] within | | | | | |
| | | last [xx] days.. | | | | | |
| | 10 | If party collection i.d. range [xxx to yyy using specified digits | negative status code | Offer Type; Offer Category; | | Each LOB needs to define | LOB |
| | | of the party collection i.d.] with Segment Type [using | suppressions | Accounts Type; Negative | | negative status codes and where | Specific |
| | | customer segment type] Suppress offer type [using offer | | Status Code | | negative status codes can be | |
| | | type and offer category] with accounts [using account types] | | | | found. | |
| | | who have negative status codes [using status code] | | | | | |
| | 11 | If party collection i.d. range [xxx to yyy using specified digits | Confirm external | offer type; offer category; | | example: Mortgage trigger offer | LOB |
| | | of the party collection i.d.] with Segment Type [using | event trigger occurred | external/internal event | | in optimized file is not valid | Specific |
| | | customer segment type] Suppress offer type [using offer type | recently or drop | trigger; | | without a trigger event occurring | |
| | | and category] if external or internal event trigger file has not | trigger based offers | | | in last xx days. External and | |
| | | been updated with a trigger event [external event trigger | | | | Internal Trigger Event files will | |
| | | type] within the last [xx] days | | | | need to be loaded daily. | |
| | 12 | If party collection i.d. range [xxx to yyy using specified digits | insufficient available | | | example: Balance Transfer offer | LOB |
| | | of the party collection i.d.] with Segment Type [using | credit suppression | | | with insufficient available credit | Specific |
| | | customer segment type] Suppress offer type [using offer type | | | | | |
| | | and category] if related account does not have sufficient | | | | | |
| | | available credit [$$ amount] | | | | | |
| | 13 | If party collection i.d. range [xxx to yyy using specified digits | too much available | | | example: Line Increase offer | LOB |
| | | of the party collection i.d.] with Segment Type [using | credit suppression | | | when unneeded | Specific |
| | | customer segment type] Suppress offer type [using offer type | | | | | |
| | | and category] if related account has more than [$$] available | | | | | |
| | | credit. | | | | | |
| | 14 | If party collection i.d. range [xxx to yyy using specified digits | Change in activity | | | example: Activation offer when | LOB |
| | | of the party collection i.d.] with Segment Type [using | status indicator | | | account has activated since | Specific |
| | | customer segment type] Suppress offer type [using offer type | suppression | | | batch file was created | |
| | | and category] if related account has changed activity status | | | | | |
| | | [activity status] since last batch file load. | | | | | |
| | 15 | Suppress offer type [using offer type and category] if related | Home Ownership | | | example: Offer available to | LOB |
| | | ptycl_id is a non-homeowner since last batch file load. | based products | | | qualified ptycl_id. Will this | Specific |
| | | | | | | actually update between | |
| | | | | | | batches? | |
| | 16 | If party collection i.d. range [xxx to yyy using specified digits | Determine eligibility | party collection id, | 1 instance of a | open question: is line assignment | LOB |
| | | of the party collection i.d.] with Segment Type [using | for specialized offers | customer segment type, | continuous variable: | dependent on product type or | Specific |
| | | customer segment type] suppress offer [Offer Type or Offer | such as card line | offer type, offer category, | line increase offer | independent? Fico Score | |
| | | Category] and when time since last [account activity type 1] | increase or upgrade | time since last retail | based on EPA's line | Requirement? Can this be | |
| | | of [less than x] days [and/or] time since last [account activity | | purchase, time since last | increase amount | replaced with optimized file? | |
| | | type 2] of [less than x] days and time since last activity date | | BT, time since last cash | variable | | |
| | | [accounts activity type 3] is [greater than or less than] [x] | | advance, available credit, | | | |
| | | days and open to buy is less than [amount] or greater than | | eligible line increase | | | |
| | | [amount]. | | amount | | | |
| | 17 | If party collection i.d. range [xxx to yyy using specified digits | Determine eligibility | Party collection i.d., | 5 instances: price | profit model score can be used in | LOB |
| | | of the party collection i.d.] with Segment Type [using | for special offers such | customer segment type, | decrease offer | batch and then the offer | Specific |
| | | customer segment type] Suppress offer type of [offer type or | as price decrease | offer type or category, | based on profitability | suppressed here. | |
| | | offer category such as price decrease] when account type | | account type, account | model score and | | |
| | | [account type such as credit card] time since [transaction | | transactions such as retail | maximum of 5 | | |
| | | type 1 such as last retail purchase] was within [x] days | | purchase/BT/cash | potential price points | | |
| | | [and/or] time since [transaction type 2 such as BT] was | | advance, available credit. | | | |
| | | within [x] days [and/or] time since [transaction type 3 such as | | | | | |
| | | last cash advance] was within [x] days [and/or] available | | | | | |
| | | credit is [greater than or less than] [$x, xxx]. | | | | | |
| | 18 | For party collection i.d [xxx to yyy] with small business | too much credit | | | example: Business has an | SB Specific |
| | | relationship indicator, Suppress offer type [using offer type | exposure suppress | | | exposure greater than minimum | |
| | | and category] if related account has more than [$$] available | offer if available credit | | | potential credit offer | |
| | | credit. | >X. | | | | |
| | 19 | For party collection i.d [xxx to yyy] with small business | too much credit | | | example:- | SB Specific |
| | | relationship indicator, Suppress offer type [using offer type | exposure suppress | | | | |
| | | and category] if related account [account type] has more | offer if delinquent | | | | |
| | | than [#] delinquent status/charge off [status] | status = X to charge | | | | |
| | | | off status = X. | | | | |
| | 20 | For party collection i.d [xxx to yyy] with small business | Fraud alert | | | | SB Specific |
| | | relationship indicator. Suppress offer type [using offer type | | | | | |
| | | and category] if related account has fraud indicator [type]. | | | | | |
| | 21 | For party collection i.d [xxx to yyy] with customer segment | Fraud alert for | | | | |
| | | code [customer segment code], Suppress offer type [using | consumer offers | | | | |
| | | offer type and category] if related account has fraud indicator | | | | | |
| | | [type]. | | | | | |
| | 22 | For party collection i.d. range [xxx to yyy using specified | Suppress offers | | | | |
| | | digits of the party collection i.d.], with Segment Type [Using | served multiple times | | | | |
| | | Customer Segment Type], Suppress Offer Types [Using | in a given period | | | | |
| | | Offer type and/or Offer Category] for customers who have | | | | | |
| | | been presented the offer more than [xxx times] within the last | | | | | |
| | | [xxx using # of days]. | | | | | |
| | 23 | For party collection i.d. range [xxx to yyy using specific digits | Append LTA score for | collection i.d.; Segment | | recondition offer | LOB |
| | | of the party collection i.d.] with Segment Type [Using | system generated | Type; offer type or category | | | Specific |
| | | Customer Segment Type] and with reconditioned offer | offers (reconditioned | | | | |
| | | indicator with blank LTA score, match to optimization batch | offers) | | | | |
| | | file and append LTA score for matching offer category. | | | | | |
| | 24a | For party collection i.d. range [xxx to yyy using specific digits | LTA Update based on | collection i.d.; Segment | | | Enterprise |
| | | of the party collection i.d.] with Segment Type [Using | recent activity using | Type; Loyalty Score; offer | | | & LOB rules |
| | | Customer Segment Type], Loyalty Score Range [xxx-yyy | rules 6.4.4.1-6.4.4.6 | type or category | | | |
| | | Use Loyalty Score from Batch Load] and offer [offer type and | | | | | |
| | | offer category] based on logic [use logic from sub-rules | | | | | |
| | | related to 24 below] to modify the LTA or SVA | | | | | |
| | 24b | A) [offer type or category], [increase or decrease] LTA score | change LTA based on | offer type or category; | | | Enterprise |
| | | [x %] based on [Offer State code] and [Offer State Reason | State Code and Offer | increase/decrease; x %; | | | & LOB rules |
| | | Code] of [offer type] occurring since last batch file load | State Reason Code of | Offer State code; Offer | | | |
| | | | other offers | State Reason Code | | | |
| | 24c | B) [offer type or category], [increase or decrease] LTA score | change LTA based on | offer type or category; | | specify within last 30 days | Enterprise |
| | | [X %] based on new account application or opening [account | recent acquisition of | increase/decrease; x %; | | | & LOB rules |
| | | type] occurring since last batch file load. | other accounts | account type; | | | |
| | 24d | C) [offer type or category], [increase or decrease] LTA score | change LTA based on | offer type or category; | | If Customer Problem Indicator | Enterprise |
| | | [x %] based on customer problem indicator [indicator type] | recent customer | increase/decrease; x %; | | Database Exists. | & LOB rules |
| | | updated since last batch file load. | problem indicator | customer problem indicator | | | |
| | 24e | D) [offer type or category], increase or decrease] LTA score | change LTA based on | offer type or category; | | | Enterprise |
| | | [x %] based on the number [equal to or greater than x] of | the number of times a | increase/decrease; x %; | | | & LOB rules |
| | | offers [offer type or category] presented since date of last | type of offer has been | Number of offer type or | | | |
| | | batch file load. | presented | category | | | |
| | 24f | E) [offer type or category], [increase or decrease] LTA score | change LTA based on | offer type or category; | | This leverages customer | Enterprise, |
| | | [x %] [and/or] [increase or decrease] based on customer | customer | increase/decrease; x %; | | segmentation group code from | Segment & |
| | | segmentation group code [segmentation group code] | segmentation group | segmentation group code | | batch file. It is Not the same as | LOB rules |
| | | | code | | | Customer Segment Type. | |
| | 24g | F) [offer type or category], [increase or decrease] LTA score | change LTA based on | offer type; offer category; | | example: number of debit card | LOB |
| | | [X %] based on [number] of [transaction type] occurring on | customer behavior on | increase or decrease; | | transactions or ATM usage | specific |
| | | [account type] since last batch file. | existing accounts | number; transaction type; | | | |
| | | | | account type; | | | |
| | 24h | K) [offer type or category], [increase or decrease] LTA score | change LTA based on | offer type or category; | | | SB Specific |
| | | [x %] based on seasonal buying product patterns [seasonal | Seasonal priority | increase/decrease; x %; | | | |
| | | priority provided by batch file process] | | Seasonal priority | | | |
| | 24i | L) [offer type or category], [increase or decrease] LTA score | change LTA based on | offer type or category; | | | SB Specific |
| | | [x %] based on a recent event in customer accounts [events] | customer events | increase/decrease; x %; | | | |
| | | | | Event | | | |
| | 24j | For party collection i.d. range [xxx to yyy using specific digits | Append SVA for | collection i.d.; Segment | | Reconditioned | LOB |
| | | of the party collection i.d.] with Segment Type [Using | system generated | Type; offer type or category | | | Specific |
| | | Customer Segment Type] and with [offer type or category] | offers (1) | | | | |
| | | with blank SVA score, match to optimization batch file and | | | | | |
| | | append SVA for matching offer category. | | | | | |
| | 24k | For party collection i.d. range [xxx to yyy using specific digits | accommodate | | | | LOB |
| | | of the party collection i.d.] with request coming from channel | changes to LTA | | | | Specific |
| | | [channel indicator] and Segment Type [Using Customer | based on separate | | | | |
| | | Segment Type] and with [offer type or category] with | retention score | | | | |
| | | retention score range [xx using retention score from batch | ranges by channel | | | | |
| | | file] modify LTA [x %]. | | | | | |
| | 25 | For Card Services BT offers with blank “Offer” field, select | | | | BT offer only. | LOB |
| | | “best” offer associated with the Offer Category using the | | | | | Specific |
| | | CTCS. Use BAU logic | | | | | |

Assemble List for Sequencing

| | | | | |
|---|---|---|---|---|
| I | 1 | For party collection i.d. range [xxx to yyy using specific digits | Suppress EPA | LOB |
| | | of the party collection i.d.] and Segment Type [Using | request for offers with | Specific |
| | | Customer Segment Type] and with [offer type or category] | LTA below cost | |
| | | suppress EPA request with LTA value less than [xxx].. | benefit level. | |

Product Best Fit

| | | | | |
|---|---|---|---|---|
| J | 1 | For parties with collection i.d. range [xxx to xxx] randomly | Expand the card | Card |
| | | assign offer from the expanded Card Services best fit list. | product offers beyond | Services |
| | | | the BAU set using | Specific |
| | | | “product walk” logic | |
| | | | and assign some of | |
| | | | the offers randomly | |
| | 2 | For parties with collection i.d. range [xxx to xxx] assign offer | Expand the card | Card |
| | | from the expanded Card Services best fit list using expanded | product offers beyond | Services |
| | | product assignment logic. | the BAU set using | Specific |
| | | | “product walk” logic | |

Sort & Order Offers

| | | | | | | |
|---|---|---|---|---|---|---|
| K | 1 | For party collection range [xxx to yyy using specific digits of | Create launch | | The percent of population using | Enterprise |
| | | the party collection i.d.] with Segment Type [using customer | Champion strategy | | this strategy will reduce in regular | |
| | | segment type], exactly replicate Offers Management | that mirrors the pre- | | intervals over time to 0% as | |
| | | Generation 1 offer generation rules and sequencing process. | OM environment | | random digits are moved out of | |
| | | | | | this strategy. | |
| | 2 | For party collection i.d. range [xxx to yyy using specific digits | Sort rule for random | collection i.d. digits; | | Enterprise |
| | | of the party collection i.d.] and segment type [using customer | sequence control | customer segment type | | |
| | | segment type] randomly sort all offers. | strategy | | | |
| | 3 | For party collection i.d. range [as specified in 21.2.1] and | Random sequence | collection i.d. digits; | | Enterprise |
| | | segment type [using customer segment type] allow up to | control strategy # of | customer segment type, # | | |
| | | maximum of [x] offers to be served starting with position 1. | offers to serve | of offers | | |
| | 4 | For party collection i.d. range [xxx to yyy] suppress all offers. | No passive offer | collection i.d. digits | | Enterprise |
| | | | control strategy | | | |
| | | | suppression rule | | | |
| | 5 | For party collection i.d. range [as specified in 21.3.1] allow no | No passive offer | collection i.d. digits | | Enterprise |
| | | passive offers to be served | control strategy, # | | | |
| | | | offers served rule | | | |
| | 6 | For Challenger strategies, Place Offers with a | “REQUESTED” state | none | Requested offer positioning does | Enterprise |
| | | “REQUESTED” state in position 1 regardless of all other | offers in sort | | not apply to Launch Champion, | |
| | | rule. Sort multiple REQUESTED offers by SVA (highest on | position 1 | | No Offer of Random Strategies | |
| | | top). | | | | |
| | 7 | For challenger strategies Place Offers with an | “INTERESTED” state | none | | |
| | | “INTERESTED” state in sort positions immediately behind | offers following | | | |
| | | “REQUESTED” state offers regardless of all other rule. Sort | REQUESTED state | | | |
| | | multiple INTERESTED offers by SVA (highest on top). | offers | | | |
| | 8 | for challenger strategies Sort remaining offers based on | how to handle other | none | | Enterprise |
| | | party collection i.d. rules in rules 21.2.1 and following filling | offers included in a | | | |
| | | sort positions below REQUESTED and INTERESTED offers | list with REQUESTED | | | |
| | | sorted by rule 21.1.1 | and INTERESTED | | | |
| | | | offers | | | |
| | 9a | For Party i.d. range [xxx to yyy] and segment type [customer | Challenger 1 - LTA | collection i.d., segment | | Enterprise |
| | | segment type] sort passive offers based on batch optimized | only sorting strategy | type | | |
| | | file sequence. | | | | |
| | 9b | For party i.d. range [as specified in 9a] and segment type [as | Challenger 1 - LTA | collection i.d., segment | | Enterprise |
| | | specified in 9a] insert non-batch offers into the batch | only sorting strategy | type | | |
| | | sequence 1 position above or below the batch offer with the | | | | |
| | | closest LTA score to the non-batch offer. Use the highest | | | | |
| | | sorted batch offer when there is more than 1 with the same | | | | |
| | | LTA. Place the non-batch offer above when the LTA is | | | | |
| | | higher and below when it is equal to or lower. | | | | |
| | 9c | For party i.d. range [as specified in 9a] and segment type [as | Challenger 1 - LTA | collection i.d.; % change in | | Enterprise |
| | | specified in 9a] move batch offers which have increased LTA | only sorting strategy | LTA of an offer from it's | | |
| | | by more than [x %] over the original batch LTA value up [x] | | original batch LTA; number | | |
| | | position(s) in the batch sequence and move batch offers | | of positions in sort | | |
| | | which have decreased LTA by [x %] under the original batch | | | | |
| | | LTA value down [x] position(s) in the batch sequence. | | | | |
| | 9d | For party i.d. range [as specified in 9a] and segment type [as | Challenger 1 - LTA | collection i.d. digits; # | | Enterprise |
| | | specified in 9a] allow up to maximum of [x] offers to be | only sorting Strategy, | offers Served | | |
| | | served starting with position 1. | # offers served rule | | | |
| | 10a | For Party i.d. range [xxx to yyy] and segment type [customer | Challenger 2 - LTA & | collection i.d., segment | | Enterprise |
| | | segment type] sort passive offers based on batch optimized | SVA sorting strategy | type | | |
| | | file sequence. | | | | |
| | 10b | For party i.d. range [as specified in 10a] and segment type | Challenger 2 - LTA & | collection i.d., segment | | Enterprise |
| | | [as specified in 10a] calculate LTA/SVA value (LTA * SVA) for | SVA sorting strategy | type | | |
| | | each offer. Insert non-batch offers into the batch sequence 1 | | | | |
| | | position above or below the batch offer with the closest | | | | |
| | | LTA/SVA value score to the non-batch offer. Use the highest | | | | |
| | | sorted batch offer when there is more than 1 with the same | | | | |
| | | LTA/SVA. Place the non-batch offer above when the | | | | |
| | | LTA/SVA is higher and below when it is equal to or tower. | | | | |
| | 10c | For party i.d. range [as specified in 10a] and segment type | Challenger 2 - LTA & | collection i.d.; % change in | | Enterprise |
| | | [as specified in 10a] move batch offers which have increased | SVA sorting strategy | LTA/SVA of an offer from | | |
| | | LTA/SVA (LTA * SVA) by more than [x %] over the original | | it's original batch LTA/SVA; | | |
| | | batch LTA/SVA value up [x] position(s) in the batch | | number of positions in sort | | |
| | | sequence and move batch offers which have decreased | | | | |
| | | LTA/SVA by [x %] under the original batch LTA value down | | | | |
| | | [x] position(s) in the batch sequence. | | | | |
| | 10d | For party i.d. range [as specified in 10a] and segment type | Challenger 1 - LTA | collection i.d. digits; # | | Enterprise |
| | | [as specified in 10a] allow up to maximum of [x] offers to be | only sorting Strategy, | offers served | | |
| | | served starting with position 1. | # offers served rule | | | |
| | 11a | For Party i.d. range [xxx to yyy] and segment type [customer | Challenger 3 - LTA | collection i.d., segment | | Enterprise |
| | | segment type] sort passive offers based on batch optimized | sequencing strategy | type | | |
| | | file sequence. | | | | |
| | 11b | For party i.d. range [as specified in 11a] and segment type | Challenger 3 - LTA | collection i.d., segment | | Enterprise |
| | | [as specified in 11a] calculate LTA value for each offer. Insert | sequencing strategy | type | | |
| | | non-batch offers into the batch sequence 1 position above or | | | | |
| | | below the batch offer with the closest LTA value score to the | | | | |
| | | non-batch offer. Use the highest sorted batch offer when | | | | |
| | | there is more than 1 with the same LTA. Place the non- | | | | |
| | | batch offer above when the LTA is higher and below when it | | | | |
| | | is equal to or lower. | | | | |
| | 11c | For party i.d. range [as specified in 11a] and segment type | Challenger 3 - LTA | collection i.d.; % change in | | Enterprise |
| | | [as specified in 11a] move batch offers which have | sequencing strategy | LTA/SVA of an offer from | | |
| | | increased LTA by more than [x %] over the original batch LTA | | it's original batch LTA/SVA; | | |
| | | value up [x] position(s) in the batch sequence and move | | number of positions in sort | | |
| | | batch offers which have decreased LTA by [x %] under the | | | | |
| | | original batch LTA value down [x] position(s) in the batch | | | | |
| | | sequence. | | | | |
| | 11d | For party i.d. range [as specified in 11a] and segment type | Challenger 3 - LTA | collection i.d. range, | | Enterprise |
| | | [as specified in 11a] move offers which have been [served or | sequencing strategy | customer segment type, | | |
| | | presented] within the last [x] days below the serving cut-off | | date last served, date last | | |
| | | point identified in rule 21.6.5 and move offers up that have | | presented to customer | | |
| | | not been [served or presented] in last [x] days as needed to | | | | |
| | | fill open sort positions from offers moved down. | | | | |
| | 11e | For party i.d. range [as specified in 11a] and segment type | Challenger 3 - LTA | collection i.d. digits; # | | Enterprise |
| | | [as specified in 11a] allow up to maximum of [x] offers to be | sequencing strategy | offers served | | |
| | | served starting with position 1. | | | | |
| | 12a | For Party i.d. range [xxx to yyy] and segment type [customer | Challenger 4 - | collection i.d., segment | | Enterprise |
| | | segment type] sort passive offers based on batch optimized | Grouping offer type | type | | |
| | | file sequence. | sequencing strategy | | | |
| | 12b | For party i.d. range [as specified in 12a] and segment type | Challenger 4 - | collection i.d., segment | | Enterprise |
| | | [as specified in 12a] calculate LTA value for each offer. Insert | Grouping offer type | type | | |
| | | non-batch offers into the batch sequence 1 position above or | sequencing strategy | | | |
| | | below the batch offer with the closest LTA value score to the | | | | |
| | | non-batch offer. Use the highest sorted batch offer when | | | | |
| | | there is more than 1 with the same LTA. Place the non- | | | | |
| | | batch offer above when the LTA is higher and below when it | | | | |
| | | is equal to or lower. | | | | |
| | 12c | For party i.d. range [as specified in 12a] and segment type | Challenger 4 - | collection i.d.; % change in | | Enterprise |
| | | [as specified in 12a] move batch offers which have increased | Grouping offer type | LTA of an offer from it's | | |
| | | LTA by more than [x %] over the original batch LTA value up | sequencing strategy | original batch LTA; number | | |
| | | [x] position(s) in the batch sequence and move batch offers | | of positions in sort | | |
| | | which have decreased LTA by [x %] under the original batch | | | | |
| | | LTA value down [x] position(s) in the batch sequence. | | | | |
| | 12d | For party i.d. range [as specified in 12a] and segment type | Challenger 4 - | collection i.d. range. | | Enterprise |
| | | [as specified in 12a]move offers [offer type such as retention] | Grouping offer type | customer segment type, | | |
| | | so that they group (in order) immediately following the | sequencing strategy | offer type or category | | |
| | | highest sorted offer of the same offer category. | | | | |
| | 12e | For party i.d. range [as specified in 12a] and segment type | Challenger 4 - | collection i.d. digits; # | | Enterprise |
| | | [as specified in 12a] allow up to maximum of [x] offers to be | Grouping offer type | offers served | | |
| | | served starting with position 1. | sequencing strategy | | | |
| | 13a | For Party i.d. range [xxx to yyy] and segment type [customer | Challenger 5 - | collection i.d., segment | | Enterprise |
| | | segment type] sort passive offers based on batch optimized | Triggers to the top | type | | |
| | | file sequence. | strategy | | | |
| | 13b | For party i.d. range [as specified in 13a] and segment type | Challenger 4 - | collection i.d., segment | | Enterprise |
| | | [as specified in 13a] calculate LTA value for each offer. Insert | Grouping offer type | type | | |
| | | non-batch offers into the batch sequence 1 position above or | sequencing strategy | | | |
| | | below the batch offer with the closest LTA value score to the | | | | |
| | | non-batch offer. Use the highest sorted batch offer when | | | | |
| | | there is more than 1 with the same LTA. Place the non- | | | | |
| | | batch offer above when the LTA is higher and below when it | | | | |
| | | is equal to or lower. | | | | |
| | 13c | For party i.d. range [as specified in 13a] and segment type | Challenger 4 - | collection i.d.; % change in | | Enterprise |
| | | [as specified in 13a]move batch offers which have increased | Grouping offer type | LTA of an offer from it's | | |
| | | LTA by more than [x %] over the original batch LTA value up | sequencing strategy | original batch LTA; number | | |
| | | [x] position(s) in the batch sequence and move batch offers | | of positions in sort | | |
| | | which have decreased LTA by [x %] under the original batch | | | | |
| | | LTA value down [x] position(s) in the batch sequence. | | | | |
| | 13d | For party i.d. range [as specified in 13a] and segment type | Challenger 4 - | collection i.d. range, | | Enterprise |
| | | [as specified in 13a] move offers [offer type such as triggers] | Grouping offer type | customer segment type, | | |
| | | so that they group at the top of the sort immediately following | sequencing strategy | offer type or category | | |
| | | any requested offers. | | | | |
| | 13e | For party i.d. range [as specified in 13a] and segment type | Challenger 4 - | collection i.d. digits; # | | Enterprise |
| | | [as specified in 13a] allow up to maximum of [x] offers to be | Grouping offer type | offers served | | |
| | | served starting with position 1. | sequencing strategy | | | |
| | 14a | For Party i.d. range [xxx to yyy] and segment type [customer | Challenger 5 - | collection i.d., segment | | Enterprise |
| | | segment type] sort passive offers based on batch optimized | Minimum LTA only | type | | |
| | | file sequence. | sorting strategy | | | |
| | 14b | For party i.d. range [as specified in 14a] and segment type | Challenger 5 - | collection i.d., segment | | Enterprise |
| | | [as specified in 14a] insert non-batch offers into the batch | Minimum LTA only | type | | |
| | | sequence 1 position above or below the batch offer with the | sorting strategy | | | |
| | | closest LTA score to the non-batch offer. Use the highest | | | | |
| | | sorted batch offer when there is more than 1 with the same | | | | |
| | | LTA. Place the non-batch offer above when the LTA is | | | | |
| | | higher and below when it is equal to or lower. | | | | |
| | 14c | For party i.d. range [as specified in 14a] and segment type | Challenger 5 - | collection i.d.; % change in | | Enterprise |
| | | [as specified in 14a] move batch offers which have increased | Minimum LTA only | LTA of an offer from it's | | |
| | | LTA by more than [x %] over the original batch LTA value up | sorting strategy | original batch LTA; number | | |
| | | [x] position(s) in the batch sequence and move batch offers | | of positions in sort | | |
| | | which have decreased LTA by [x %] under the original batch | | | | |
| | | LTA value down [x] position(s) in the batch sequence. | | | | |
| | 14d | For party collection i.d. range [as specified in 14a] and | Challenger 5 - | collection i.d. digits; # | | Enterprise |
| | | segment type [as specific in 14a] allow up to maximum of [x] | Minimum LTA only | offers served | | |
| | | offers to be served starting with position 1 and serving only | sorting strategy | | | |
| | | those offers with a minimum LTA Value above [x.xx]. | | | | |
| | 15a | For Party i.d. range [xxx to yyy] and segment type [customer | Challenger 6 - Forced | collection i.d., segment | | Enterprise |
| | | segment type] sort passive offers based on batch optimized | product sorting | type | | |
| | | file sequence. | strategy | | | |
| | 15b | For party i.d. range [as specified in 15a] and segment type | Challenger 6 - Forced | collection i.d., segment | | Enterprise |
| | | [as specified in 15a] insert non-batch offers into the batch | product sorting | type | | |
| | | sequence 1 position above or below the batch offer with the | strategy | | | |
| | | closest LTA score to the non-batch offer. Use the highest | | | | |
| | | sorted batch offer when there is more than 1 with the same | | | | |
| | | LTA. Place the non-batch offer above when the LTA is | | | | |
| | | higher and below when it is equal to or lower. | | | | |
| | 15c | For party i.d. range [as specified in 15a] and segment type | Challenger 6 - Forced | collection i.d.; % change in | | Enterprise |
| | | [as specified in 15a] move batch offers which have increased | product sorting | LTA of an offer from it's | | |
| | | LTA by more than [x %] over the original batch LTA value up | strategy | original batch LTA; number | | |
| | | [x] position(s) in the batch sequence and move batch offers | | of positions in sort | | |
| | | which have decreased LTA by [x %] under the original batch | | | | |
| | | LTA value down [x] position(s) in the batch sequence. | | | | |
| | 15d | For party i.d. range [as specified in 15a] and segment type | Challenger 6 - Forced | collection i.d. digits; # | | Enterprise |
| | | [as specified in 15a] sort all offers [offer type or category] to | product sorting | offers served | | |
| | | the top of the list. | strategy | | | |
| | 15d | For party i.d. range [as specified in 15a] and segment type | Challenger 6 - Forced | collection i.d. digits; # | | Enterprise |
| | | [as specified in 15a] allow up to maximum of [x] offers to be | product sorting | offers served | | |
| | | served starting with position 1. | strategy | | | |

What is claimed is:

1. A method for selecting an offer for presentation to a customer of an entity, the method comprising:
retrieving historical customer data;
formulating an offer based on the historical customer data; and,
based at least in part on recent customer data, determining whether to present the offer to the customer.

2. The method of claim 1 further comprising optimizing the historical data to produce a synoptic data corresponding to the customer, the synoptic data set including at least one data record that correspond to a customer attribute.

3. The method of claim 2 wherein the optimizing the historical data to produce a synoptic data corresponding to the customer, comprises generating at least one offer that correspond to a customer attribute.

4. The method of claim 2 wherein the optimizing historical customer data comprises analyzing a plurality of historical customer interaction records, each historical customer interaction record corresponding to an interaction between the customer and the entity.

5. The method of claim 4 wherein the analyzing comprises evaluating each historical customer interaction record based on a parameter selected by the entity, the parameter corresponding to an entity marketing objective.

6. The method of claim 4 wherein the optimizing historical customer data comprises evaluating each historical customer interaction record based on a historical offer associated with the record.

7. The method of claim 4 wherein the formulating comprises applying at least one rule to each historical customer interaction record.

8. The method of claim 7 wherein the determining whether to present the offer to the customer comprises eliminating the offer based on the recent customer data.

9. The method of claim 7 wherein the determining further comprises eliminating the offer based on a correspondence between the offer and a previously prevented offer included in the recent customer data.

10. The method of claim 7 wherein the determining further comprises eliminating the offer based on a correspondence between the offer and a previously acquired product included in the recent customer data.

11. The method of claim 1 further comprising:
presenting the offer to the customer;
receiving customer response information from the customer in response to the offer; and
updating the recent customer data using the customer response information.

12. One or more computer-readable medium storing computer-executable instructions which, when executed by a processor on a computer system, performs a method for selecting an offer for presentation to a customer of an entity, the method comprising:
optimizing historical customer data;
formulating an offer based on the historical customer data; and,
based at least in part on recent customer data, determining whether to present the offer to the customer;
wherein the optimizing historical customer data comprises analyzing a plurality of historical customer interaction records, each historical customer interaction record corresponding to an interaction between the customer and the entity.

13. The media of claim 12 wherein, in the method, the analyzing comprises evaluating each historical customer interaction record based on a parameter selected by the entity, the parameter corresponding to a entity marketing objective.

14. The media of claim 12 wherein, in the method, the optimizing historical customer data comprises evaluating each historical customer interaction record based on a historical offer associated with the record.

15. The media of claim 12 wherein, in the method, the formulating comprises applying at least one rule to each historical customer interaction record.

16. The media of claim 12 wherein, in the method, the determining whether to present the offer to the customer comprises eliminating the offer based on the recent customer data.

17. The media of claim 16 wherein, in the method, the determining further comprises eliminating the offer based on a correspondence between the offer and a previously prevented offer included in the recent customer data.

18. The media of claim 16 wherein, in the method, the determining further comprises eliminating the offer based on a correspondence between the offer and a previously acquired product included in the recent customer data.
